(19) United States
(12) Patent Application Publication
(10) Pub. No.: US 2004/0139063 A1
(43) Pub. Date: Jul. 15, 2004

(54) Pipelined binary search machine

(76) Inventors: Reuven Moskovich, Tel-Aviv (IL); Eliezer Levy, Haifa (IL)

Correspondence Address: William H. Dippert, Esq., Reed Smith LLP, 29th Floor, 599 Lexington Avenue, New York, NY, 10022-7650, US

(21) Appl. No.: 10/342,057

(22) Filed: Jan. 14, 2003

(51) Int. Cl. G06F 7/00

(52) U.S. Cl. 707/3

(57) ABSTRACT

A binary search machine, comprising an input line adapted to receive an input value, a first comparator adapted to provide an indication of a sub-portion of a database index covering a range including the input value; and one or more additional comparators, arranged in a cascade with the first comparator, such that each additional comparator is adapted to receive, from a previous comparator in the cascade, an indication of a first portion of the database index in which to search for the input value and to provide an indication of a sub-portion of the first portion, covering a range including the input value.

### FIELD OF THE INVENTION

The present invention relates generally to database query systems and particularly to database binary search systems.

### BACKGROUND OF THE INVENTION

Large collections of records of data, referred to as databases, are utilized in applications throughout the entire world of computer applications. Each record generally comprises one or more fields. In many applications, a database is searched for records whose contents complies to a specific condition relating to one or more fields of the record. These fields are referred to as key fields. Generally, it is desired to receive a list of all the records, which fulfill the specific condition. Such searches may be performed by a processor using various search algorithms.

For example, in searching through a non-sorted database, a processor may perform a linear search, in which the processor sequentially searches through the records of the database, e.g., from beginning to end. When the database is sorted, the time required for an average search may be substantially reduced, for example, by using a binary search. In a binary search, the processor repeatedly compares a desired key record to a record substantially in the middle of a remaining portion of the database in which the desired record may be located. According to the results of the comparison, a portion of the database not including the desired record is determined.

When a data server performs many queries the speed of the binary search becomes of utmost importance.

In some cases, as is known in the art, a sorted index is created for a collection of records, in order to speed up the access to the data in the collection of records. By using a sorted index, queries are resolved relative to the database much faster.

Searches can be accelerated significantly by using parallel processing methods. Such methods can be applied, for example, by a machine comprising a plurality of processors, which simultaneously search through a shared copy of a database or on separate copies of a database. For example, such a machine would activate a plurality of processors searching different parts of a shared database. One of the problems with parallel methods is the cost of the hardware.

### SUMMARY OF THE INVENTION

An aspect of some embodiments of the invention relates to a cascade of three or more comparators, which jointly perform a search for an input value, in a database index. Each comparator in the cascade performs a partial search, which optionally narrows a range of records in the database index in which the input value may exist. Optionally each comparator receives an indication of a range of records to search and passes on a sub range to a succeeding comparator.

In some embodiments of the invention, the last comparator in the cascade provides a position or range corresponding to the input value. Optionally an indication is provided as to whether the input value exists in the database index and the location it occupies or would have occupied if it did exist.

In some embodiments of the invention, different comparators in the cascade search for different values at the same time. Optionally, a comparator that finishes its partial search for a specific value loads a next input value to search for, from the previous comparator in the cascade. For a large sequence of values to be searched for in the database, each comparator will optionally be engaged in parallel in a different search, in accordance with a pipeline scheme. Consequently, each time a new value is input to the cascade a processed result is output.

An aspect of some embodiments of the invention relates to a search machine, comprising a plurality of comparators, which performs a search for an input value in a database index. At least one of the comparators of the search machine searches in a dynamically selected group of records of the database index. The dynamically selected group of records is optionally chosen according to results from a different comparator in the machine and/or according to the input value. In some embodiments of the invention, all of the comparators of the search machine except one, search in dynamically selected groups of records. Optionally, the plurality of comparators are arranged in a cascade and all of the comparators, except the first comparator, search in dynamically selected groups of records. In some embodiments of the invention the first comparator performs a search in a fixed group of records independent of the input value.

In some embodiments of the invention, each of the comparators, which search dynamically selected groups of records, is associated with a memory that stores representative records of portions of the database index. According to an indication of a different comparator, the memory supplies the associated comparator with an appropriate selected group of records in which to search.

There is therefore provided in accordance with some embodiments of the present invention, a binary search machine, comprising an input line adapted to receive an input value, a first comparator adapted to provide an indication of a sub-portion of a database index covering a range including the input value and one or more additional comparators, arranged in a cascade with the first comparator, such that each additional comparator is adapted to receive, from a previous comparator in the cascade, an indication of a first portion of the database index in which to search for the input value and to provide an indication of a sub-portion of the first portion, covering a range including the input value.

Optionally, the comparators determine the sub-portion responsive to a comparison of the input value to one or more representative records of sub-portions of the first portion. Optionally, the comparators of said cascade all compare to the same number of representative records. Optionally, the first comparator of said cascade compares the input value to a greater number of representative records than any other comparator in said cascade. Optionally, at least two of the comparators of said cascade compare an input value to a different number of representative records. Optionally, the first portion of the first comparator in the cascade comprises the entire database index. Optionally, the sub-portion of a last comparator in the cascade comprises a single record from the database index. Alternatively, the sub-portion of a last comparator in the cascade comprises two records from the database index.

Further alternatively, the sub-portion of a last comparator in the cascade comprises a range of records from the database index. Optionally, the comparators are comprised of dedicated hardware elements. Optionally, the comparators comprise software modules. Optionally, at least two of said comparators are adapted to operate concurrently on different input values. Optionally, all the comparators accept an input and provide an output at substantially the same time. Optionally, a result is output from the machine as a new input value is fed in to the machine. Optionally, at least two of the comparators are supplied representative records from different sized selections of records.

There is further provided in accordance with some embodiments of the invention, a binary search machine, comprising an input line adapted to receive an input value and a plurality of comparators adapted to search for the input value, wherein at least one of the comparators performs a search on a dynamically selected groups of records.

Optionally, the dynamically selected group of records is chosen according to results from a different comparator in the machine. Alternatively or additionally, the dynamically selected group of records is chosen according to the input value. Optionally, all of the comparators of the machines except one search in a dynamically selected group of records. Optionally, the comparators are arranged in a cascade and all of the comparators except the first comparator, search in a dynamically selected group of records. Optionally, each of the comparators is associated with a memory.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a binary search system, in accordance with an exemplary embodiment of the invention;

FIG. 2 is a schematic illustration of an exemplary pipelined binary search machine, in accordance with an exemplary embodiment of the invention;

FIG. 3 is a schematic illustration of a sorted database index, divided into portions, in accordance with an exemplary embodiment of the invention;

FIG. 4 is a flowchart of an initialization process of a search machine, in accordance with an exemplary embodiment of the invention;

FIG. 5 is a flowchart of a search process in a search machine, in accordance with an exemplary embodiment of the invention; and

FIG. 6 is a schematic illustration of a dedicated hardware comparator, in accordance with an exemplary embodiment of the invention.

### DETAILED DESCRIPTION OF EMBODIMENTS

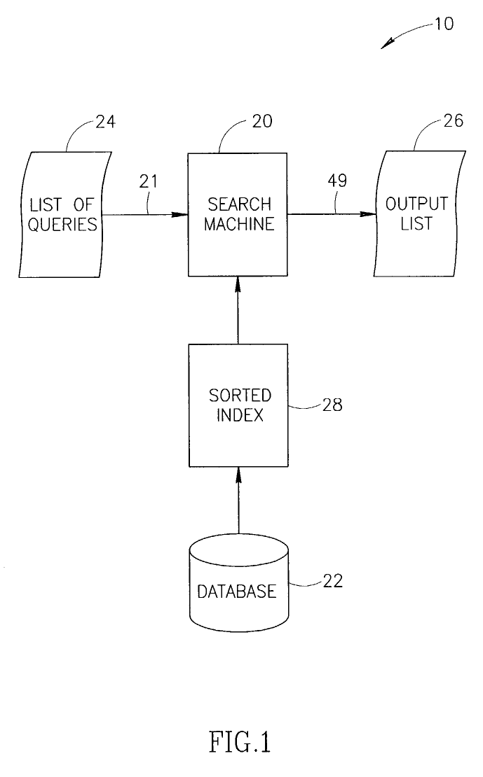

FIG. 1 is a schematic illustration of a binary search system 10, in accordance with an exemplary embodiment of the present invention. Search system 10 comprises a pipelined binary search machine 20 associated with an index 28 of a database table 22. Optionally, index 28 is sorted according to one or more key fields of database table 22, which key field is used in searching through table 22 by search system 10. Optionally, index 28 includes a single record for each key field value even if the database table 22 includes a plurality of records having the same value of the key field. Optionally, different sorted indexes 28 exist for searches with different key fields. Search machine 20 is optionally initialized with the records of an index 28 according to a method described hereinafter. In performing a search, search machine 20 optionally receives a list of queries 24 relating to specific values of the key field, and provides an output list 26 which includes for each input value a pointer to a corresponding position in database table 22 and/or in sorted index 28.

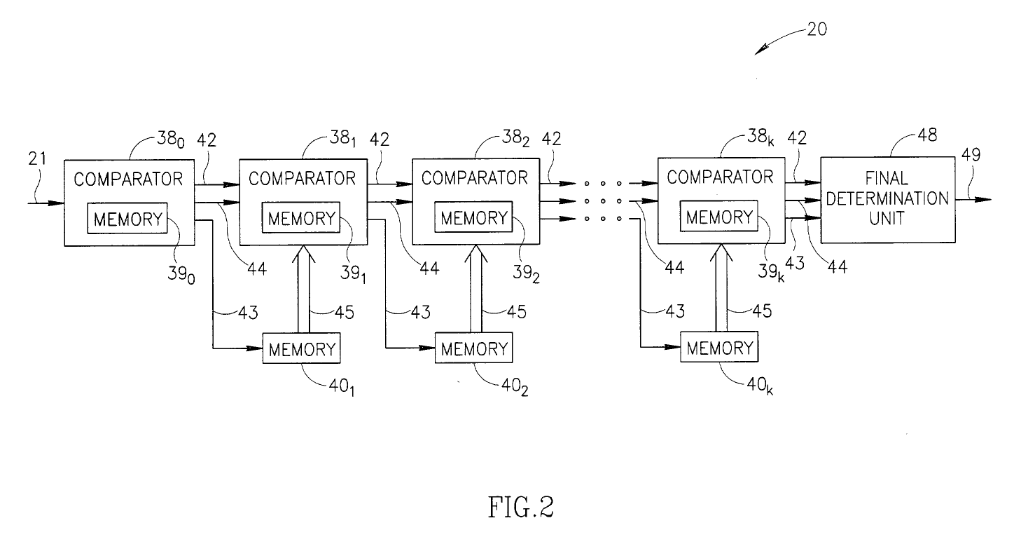

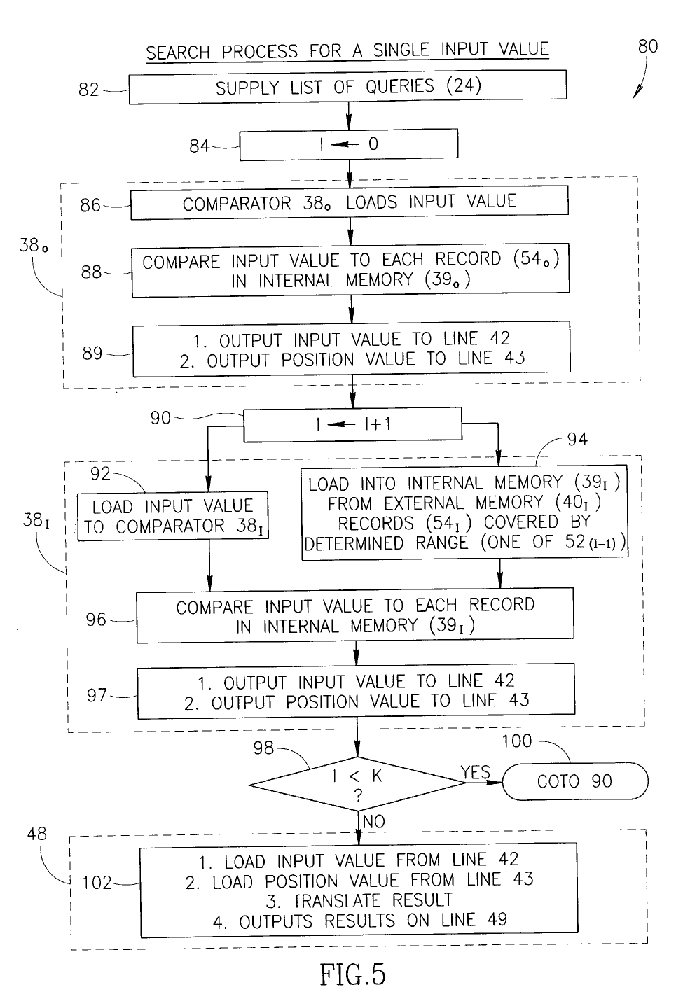

FIG. 2 is a schematic illustration of a binary search machine 20, in accordance with an exemplary embodiment of the invention. Binary search machine 20 optionally comprises a plurality of comparators 38 (marked 38₀, 38₁, . . . 38_{K} giving a total of K+1 comparators), connected in a cascade. Each comparator 38 optionally comprises a respective internal memory 39 (marked 39₀, 39₁, . . . 39_{K}). Optionally, internal memories 39 comprise register sets integrated in comparator 38, for example residing on a single chip with the respective comparator. During usage, internal memory 39 is loaded with records of index 28 to which a specific input value is compared in the respective comparator 38. Comparators 38, provide results on lines 42, 43 and 44 as described below with reference to FIG. 5.

In an exemplary embodiment of the invention, each comparator 38, except the first comparator, is connected to a memory 40 (marked 40₁, 40₂ . . . , 40_{K}). Memory 40 stores, for each possible portion of index 28 in which comparator 38 may be required to search for the input value, an array of records representing the portion. In operation, for each input value, internal memory 39 is loaded with one of the representative record arrays, as described hereinafter. Optionally, the contents of the internal memory of the first comparator 39₀, remains constant regardless of the input value searched for in the database.

In an exemplary embodiment of the invention, the last comparator 38_{K} outputs its search results to a final determination unit 48. Final determination unit 48, optionally, performs final formatting of the search results and outputs them on a line 49 as part of output list 26. For example, final determination unit 48 may receive an index to database index 28 and lookup the address in database table 22.

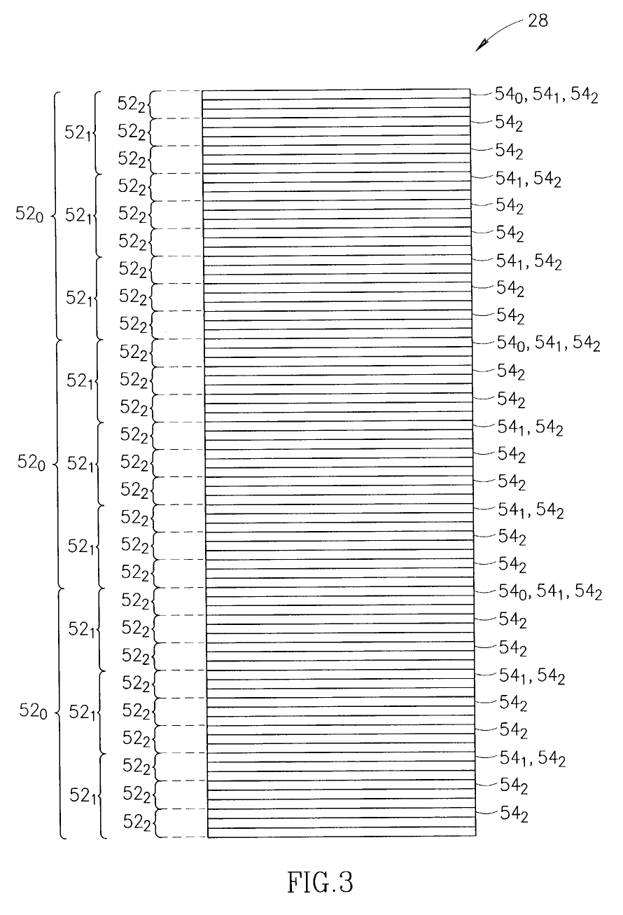

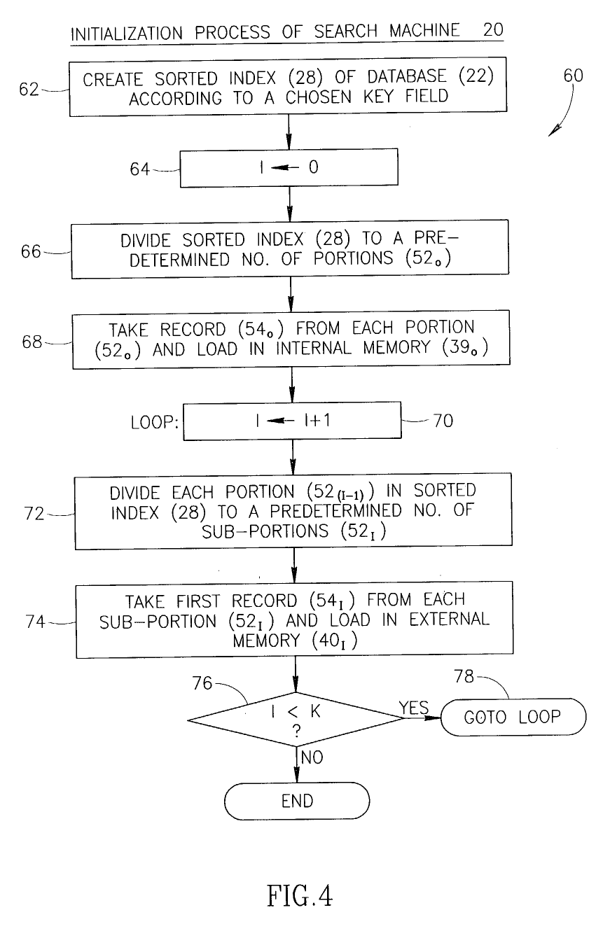

FIG. 4 shows a flowchart 60 of an initialization process of search machine 20, in accordance to an exemplary embodiment of the invention. Reference is also made to FIG. 3, which is a schematic illustration of a simplified sorted database index 28, in accordance with some embodiments of the present invention. At 62, an external computer (not shown) optionally, creates a sorted index 28 of database table 22 according to one or more key fields which are to be used in the searches performed by system 10. At 64, a counter is initialized to reference the first comparator 38₀ (I is set to zero). At 66, sorted index 28 is optionally divided to a pre-determined number of portions 52₀.

At 68, the external computer takes a representative record 54₀ from each portion 52₀ and loads these records to internal memory 39₀. Optionally, the representative record 54₀ comprises the first record (i.e. the record of the lowest value) of the portion. Alternatively, the representative record 54₀ comprises the last record of the portion.

Alternatively, a record at the border between each two portions is selected. In such an implementation, N portions 52₀ require storing only N−1 records 54₀ in memory 39₀

Optionally, the number of portions 52₀ is selected according to the number of records that can be stored in internal memory 39₀. At 70 a sequence of acts to be performed for each external memory 40_{I} (I>0) is initiated. First, the counter (I) is incremented by 1. At 72, each portion of the previous division 52_{I-1} is further divided into a pre-determined number of sub portions 52_{I}. Optionally the number of sub portions 52_{I} is determined according to the number of records that can be stored in internal memory 39_{I}.

At 74, the external computer selects an array of records 54_{I} corresponding to the subportions 52_{I} and loads these records 54_{I} into external memory 40_{I}. The representative records 54_{I} may comprise the first or last records of each portion 52_{I} or may comprise the border records between the portions 52_{I}. In step 76, the external computer checks if the counter is lower than the number of the last comparator K. If the answer is positive, the external computer returns (step 78) to 70 to repeat the previously described process (acts 72 to 74) for the rest of external memories 40. Otherwise, if the counter is not less than the number of the last comparator, the initialization process is complete and search machine 20 can start processing records from input list 24.

FIG. 5 shows a flowchart 80 of a search process for a single input value using search machine 20, according to an exemplary embodiment of the invention. In some embodiments of the invention, a list of queries 24 (FIG. 1) is supplied as input on line 21 (FIG. 2) to be searched for by search machine 20 (at 82). At 84, a virtual counter (I) used for the present explanation is initialized to 0. Blocks 86 to 89 represent the actions taken by comparator 38₀ in the search process. At 86, comparator 38₀ loads a first input value from input line 21. At 88, comparator 38₀ compares the input value to each of records 54₀ in internal memory 39₀ so as to determine the portion 52₀ corresponding to the input value. In some embodiments of the invention (at 89), comparator 38₀ outputs on line 43, a position value, which indicates which of portions 52₀ covers a range, which includes the input value.

In some embodiments of the invention, the output on line 43 includes an indication of the determined portion 52₀. Optionally, the output includes a memory address in memory 40_{I} of the record array corresponding to the determined portion 52₀. Alternatively or additionally, line 43 provides two values, for example the index of record 54₀ lower than the input value and the index of record 54₀ greater than the input value. Optionally, when a match is found with one of records 54₀, both the values are equal to the corresponding record 54₀. Alternatively or additionally, a line 44 between each comparator and a succeeding comparator, carries a binary value which is set if a match was found by the comparator 38_{I} from which line 44 originates. Further to the value or values supplied on line 43, comparator 38₀ optionally outputs the input value on line 42 to the next comparator 38₁.

At 90, the counter (I) is incremented by one to point to the next comparator. Blocks 92 to 97 represent the actions taken by each comparator 38_{I} in the search process. The first two actions (92 and 94) are optionally performed substantially at the same time. At 92, an input value from line 42 is loaded to comparator 38_{I}. At 94 memory 39_{I} is loaded with records 54_{I} according to the position value or values previously output on line 43.

In some embodiments of the invention, the transfer of the input value from comparator 38_{I-1} to 38_{I} (at 92), is performed in substantially the same amount of time as the transfer of records 54, from memory 40 to internal memory 39 (at 94). Thus, comparators 38 do not need to wait for the loading of records 54 into internal memory 39 in order to begin with act 96. Optionally, a bus 45 used for loading records 54 from memory 40 to internal memory 39, has a bandwidth greater than the bandwidth of line 42, providing the input value, by a factor substantially equal to the number of records 54 stored in internal memory 39. Alternatively or additionally, bus 45 comprises a fast bus which is faster by a factor substantially equal to the number of records 54 stored in internal memory 39.

At 96, comparator 38_{I} compares the input value loaded from line 42 with the records 54_{I} loaded into internal memory 39_{I} to determine which portion 52_{I} covers a range including the input value.

At 97, comparator 38 outputs the input value to line 42 and indication of the determined portion 52_{I} on line 43.

In some embodiments of the invention, as explained above for the first comparator 38₀, identical values on line 43 or an indication on line 44 notify the succeeding comparators 38_{I} that the value has been located.

In some embodiments of the invention, a comparator 38 that receives indication that the input value has been located, for example on line 44, can optionally ignore the indication for simplicity of operation. Alternatively, a comparator 38 can transfer the previous results without performing comparisons in order to conserve power. Further alternatively, a comparator 38 can transfer the result to the output out of turn and then accept a new input value to search for.

At act 98, if the current value of the counter (I) is smaller than the number of the last comparator in the synchronized cascade (I<K), (at 100) the search continues by repeating the process from act 90 with a succeeding comparator on a narrower range. If the counter (I) equals the number of the last comparator (K), the search has finished (act 102). The results from lines 42, 43 and 44 are optionally output to final determination unit 48, which translates the results to the form needed to be output in output list 26. Alternatively the results are output directly to output list 26.

In some embodiments of the invention, as the above cascaded search is performed proceeding from comparator to comparator, a comparator 38 that finishes its part in the search loads a new input value to search for according to the same process previously described. After initiating K+1 searches, all of comparators 38 will be engaged in parallel in different searches, thus producing a pipeline effect.

In an exemplary embodiment of the invention, a comparator cycle is defined as the time for a comparator to load an input value, load any records needed to be compared to the input value, perform the comparison and supply an output. For example steps 86 to 89 in FIG. 5 for comparator 38₀ and steps 92 to 97 in FIG. 5 for comparators 38_{I}.

In some embodiments of the invention, all comparators 38 perform a single cycle in the same time span. Alternatively or additionally, some comparators are faster than others and are synchronized by a common timing signal, indicating to the comparators when to accept new values and pass on results in order to allow the comparators to work together. Optionally, in each clock cycle, a new input value is fed into the first comparator 38₀. At each clock cycle, each comparator 38 optionally provides an indication of a portion 52 together with the input value to which the indication relates to the next comparator 38.

In some embodiments of the invention, after K+1 input values are fed into search machine 20, machine 20 outputs one result in every cycle.

In an exemplary embodiment of the invention, the last comparator 38_{K} optionally determines an exact position corresponding to the input value. In some embodiments of the invention, records 54_{K}, which are loaded into internal memory 39_{K} include substantially all the records in the database portion 52_{K-1} determined by comparator 38_{K-1} as covering the range including the input value. Alternatively, the records 54_{K} loaded into internal memory 39_{K} include every second record in the database portion 52_{K-1} determined by comparator 38_{K-1}. If a match of the input value to one of the loaded records 54_{K} is found, the position of a pointer to the matching record is provided. Otherwise, a pointer to the record between two records having records surrounding the input value, are provided. Optionally, final determination unit 48 determines, based on the pointer provided by comparator 38_{K}, the output of search machine 20.

In an exemplary embodiment of the invention, if a match to an input value is not found, search machine 20 outputs a null value. Alternatively, search machine 20 outputs a pointer to the value directly before or after the input value. Further alternatively, more than one pointer is output, for example, pointers to both the record before the position of the input value and the record after the input value in the index are provided. In an exemplary embodiment of the invention, if the input value is found both pointers point to the record.

In some embodiments of the invention, substantially all of comparators 38 perform comparisons to the same number of records 54, e.g., internal memories 39 hold the same number of records 54, designated x. The number of records 54 in each memory 40_{I} is x times the number of records in a previous memory 40_{I-1}. Hence, the numbers of records in memories 40_{I} forms a geometric series that increases with I. As described above, the last memory unit 40_{K} includes a number of records 54_{K} equal to the number of records in index 28 or to half of the number of records in index 28.

Alternatively, comparator 38₀ performs a greater number of comparisons than the other comparators 38_{I} (I>0). Optionally, the number of additional comparisons performed by comparator 38₀ beyond those performed by the other comparators 38 is determined, such that the operation time of comparator 38₀ is equal to the operation time of the other comparators 38 together with the time required for loading records 54 from memory unit 40 to internal memory 39. Further alternatively or additionally, different internal memories 39 have different sizes for example in order to fit a specific size of sorted index 28. Optionally, different comparators 38 have different processing power and the sizes of internal memories 39 are adjusted accordingly, such that substantially all of comparators 38 perform their tasks in substantially the same amount of time. In some embodiments of the invention, the sizes of internal memories 39 are powers of 2 for simplicity of implementation. Alternatively or additionally, any sizes may be used including prime numbers, so as to allow better adaptation to different sizes of indexes.

In an exemplary embodiment of the invention, sorted index 28 includes 1024 or 1025 portions 52₀ with 1024 respective records 54₀ stored in internal memory 39₀. Each of the portions 52₀ includes 16 or 17 sub portions 52₁ with 16 respective records 54₁. Accordingly, memory unit 40₁ stores 1024*16 records 54₁. Each of the sub portions 52₁ includes 16 or 17 sub portions 52₂ with 16 respective records 54₂, such that memory unit 40₂ stores 1024*16*16 records 54₂. For K=3, for example, search machine 20 can search through a database index 28 of a size up to (1024*16*16*16=4,194,304=) 222 records or (1025*17*17*17=5,035,825=) 222+841,521 records.

In some embodiments of the invention, search machine 20 is designed for a specific database with an index 28 having a predetermined size. Accordingly, the number of comparators 38 and the number of comparisons performed by each comparator 38, is predetermined. Alternatively, search machine 20 is planned for use with a plurality of indexes 28 of different sizes. The number of comparators 38 in search machine 20 and/or the maximal number of comparisons possibly performed by each comparator 38 are optionally chosen to accommodate a largest expected database index 28.

In some embodiments of the invention, when an index 28 including fewer records than can be accommodated by comparator 38 is to be searched by search machine 20, one or more of the comparators 38 (e.g., the last comparator 38_{K}) is set to perform fewer comparisons than its maximal capacity. Alternatively or additionally, one or more of the comparators 38 are bypassed, for example, such that the output of a comparator 38_{I-1} is provided to comparator 38_{I+1.} Further alternatively or additionally, one or more of the comparators 38 are configured to pass their input to their output without further actions.

In some embodiments of the invention, a plurality of search machines 20 are used in parallel and/or serial combinations to deal with a sorted database index 28 which is too large for a single search machine 20. For example, an index may be divided into several consecutive parts and each part is searched on a separate machine 20 in parallel. Input list 24 is pre-sorted and divided between the machines. In some embodiments of the invention, a plurality of search machines 20 are applied in series in which a first machine outputs a range comprising a subportion of the index in which each input value is found, and the following machines are initialized using the determined range as their index.

In an embodiment using a plurality of search machines in series, a sorted input list 24 would minimize the need to re-initialize memory 39₀ and memories 40 of the lower ranking machines 20, since groups of sequential input values would generally be searched for in the same range. Whereas a random selection of input values would require reinitializing memories 39₀ and 40 of a lower ranking machine 20 for every value.

In some embodiments of the invention, comparators 38 comprise dedicated hardware comparators. In some embodiments of the invention, each comparator 38 and memory 40 is implemented on a separate integrated circuit. Alternatively, a single integrated circuit comprises a comparator circuit 38 and its associated memory 40. Further alternatively or additionally, a plurality of comparators 38 and/or memories 40 are embedded in one integrated circuit. Alternatively or additionally, one or more of comparators 38 comprise a programmed general purpose processor. Optionally, one or more of memories 40 comprises a plurality of integrated circuits for example for a large value of K.

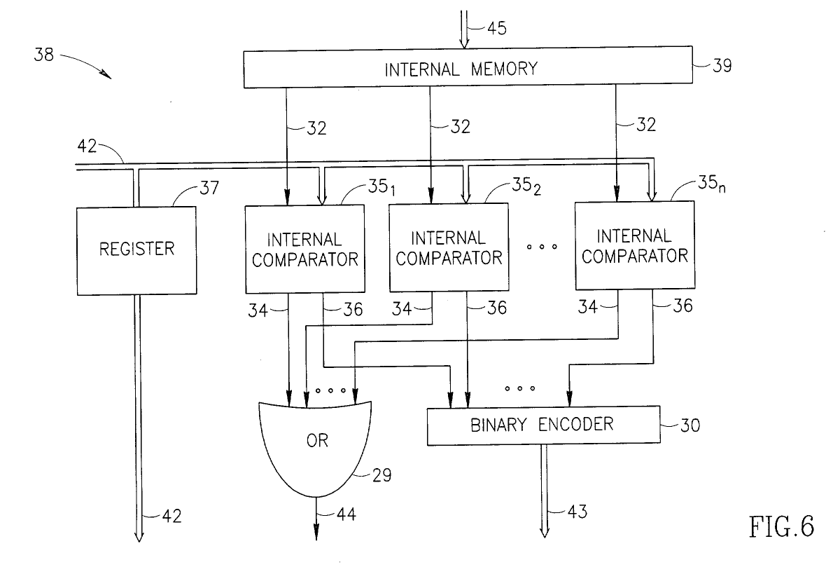

FIG. 6 is a schematic diagram of a dedicated hardware comparator 38 in accordance with an exemplary embodiment of the invention. As described above with reference to FIG. 2, comparator 38 receives an input value on line 42 and internal memory 39 of comparator 38 receives a plurality of reference records 54 on bus 45.

In an exemplary embodiment of the invention, as illustrated in FIG. 6, comparator 38 comprises a plurality of internal comparators 35 (marked 35₁, 35₂ . . . 35ₙ). In processing an input value, each internal comparator 35, receives on a respective line 32, one reference value 54_{I} from internal memory 39 (for example 54₁), and at substantially the same time perform a comparison between the input value on line 42 and the reference record 54_{I}. In some embodiments of the invention, each internal comparator 35 provides on a respective line 34, an indication on whether the reference record and input value are equal, for example a binary value which is 1 if the values are equal. Optionally, each internal comparator 35 additionally provides on a respective line 36, an indication on whether the reference record 54_{I} is greater than the input value. The values on lines 34 are optionally combined in an “or” gate 29 to form an output to line 44, which indicates whether a match has been found. The values of lines 36 are optionally combined in a binary encoder 30 to result in an indication (provided on line 43) of the index portion 52_{I} covering a range including the input value.

In some embodiments of the invention, as described previously, the output to line 43 is an indication of the position below the range 52 including the input value. Alternatively the output to line 43 is an indication of the position above the range 52 including the input value. Further alternatively the output on line 43 is an indication of the position above and below range 52. Optionally, if the input value is found the value or values output to line 43 point to the position of the input value in database index 28.

In some embodiments of the invention, comparator 38 further comprises a register 37 to hold a copy of the input value, while it is compared in internal comparators 35, and to output a copy on line 42 for succeeding comparators 38. Optionally, results are transmitted simultaneously on lines 42, 43 and 44.

It will be appreciated that the above described methods may be varied in many ways, including, changing the order of steps, and the exact implementation used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A binary search machine, comprising:
an input line adapted to receive an input value;
a first comparator adapted to provide an indication of a sub-portion of a database index covering a range including the input value; and
one or more additional comparators, arranged in a cascade with the first comparator, such that each additional comparator is adapted to receive, from a previous comparator in the cascade, an indication of a first portion of the database index in which to search for the input value and to provide an indication of a sub-portion of the first portion, covering a range including the input value.

2. A machine according to claim 1, wherein the comparators determine the sub-portion responsive to a comparison of the input value to one or more representative records of subportions of the first portion.

3. A machine according to claim 2, wherein the comparators of said cascade all compare to the same number of representative records.

4. A machine according to claim 2, wherein the first comparator of said cascade compares the input value to a greater number of representative records than any other comparator in said cascade.

5. A machine according to claim 2, wherein at least two of the comparators of said cascade compare an input value to a different number of representative records.

6. A machine according to claim 1, wherein the first portion of the first comparator in the cascade comprises the entire database index.

7. A machine according to claim 1, wherein the sub-portion of a last comparator in the cascade comprises a single record from the database index.

8. A machine according to claim 1, wherein the sub-portion of a last comparator in the cascade comprises two records from the database index.

9. A machine according to claim 1, wherein the sub-portion of a last comparator in the cascade comprises a range of records from the database index.

10. A machine according to claim 1, wherein said comparators are comprised of dedicated hardware elements.

11. A machine according to claim 1, wherein said comparators comprise software modules.

12. A machine according to claim 1, wherein at least two of said comparators are adapted to operate concurrently on different input values.

13. A machine according to claim 1, wherein all the comparators accept an input and provide an output at substantially the same time.

14. A machine according to claim 1, wherein a result is output from the machine as a new input value is fed in to the machine.

15. A machine according to claim 1, wherein at least two of the comparators are supplied representative records from different sized selections of records.

16. A binary search machine, comprising:
an input line adapted to receive an input value; and
a plurality of comparators adapted to search for the input value, wherein at least one of the comparators performs a search on a dynamically selected groups of records.

17. A machine according to claim 16, wherein the dynamically selected group of records is chosen according to results from a different comparator in the machine.

18. A machine according to claim 16, wherein the dynamically selected group of records is chosen according to the input value.

19. A machine according to claim 16, wherein all of the comparators of the machines except one search in a dynamically selected group of records.

20. A machine according to claim 16, wherein the comparators are arranged in a cascade and all of the comparators except the first comparator, search in a dynamically selected group of records.

21. A machine according to claim 16, wherein each of the comparators is associated with a memory.
